(19) United States
(12) Patent Application Publication
(10) Pub. No.: US 2005/0197991 A1
(43) Pub. Date: Sep. 8, 2005

(54) Method and apparatus for providing rule-based, autonomous software agent with ontological information

(76) Inventors: Robert E. Wray, Chapell Hill, NC (US); Jonathan T. Beard, Ann Arbor, MI (US); Sean A. Lisse, Ann Arbor, MI (US)

Correspondence Address: Allen M. Krass;Gifford, Krass, Groh, Sprinkle,, Anderson & Citkowski, P.C., 280 North Old Woodward - Suite 400, Birmingham, MI, 48009, US

(21) Appl. No.: 10/877,881

(22) Filed: Jun. 25, 2004

Related U.S. Application Data
(60) Provisional application No. 60/482,467, filed on Jun. 25, 2003.

(51) Int. Cl. G06N 5/02

(52) U.S. Cl. 706/50

(57) ABSTRACT

Autonomous systems require efficient run-time performance. In agents optimized for performance, control structures and domain knowledge are often intertwined, providing efficient execution but brittle knowledge bases that scale poorly. Combining ontology representations and agents optimized for performance can capitalize the strengths of individual approaches and reduce individual weaknesses. Automatic translators are to convert ontological representations, hand-coded procedures for ontological inference, and explanation-based learning to cache inference.

### RELATED APPLICATIONS

This application claims priority of U.S. Provisional Patent Application Ser. No. 60/482,467 filed Jun. 25, 2003, which is incorporated herein by reference.

### COMPUTER PROGRAM LISTING APPENDIX

The source code listing for the computer program Onto2Soar is attached as an appendix to this application in accordance with 37 CFR §1.52(e)(5). The complete listing file name is Onto2Soar, created on Jun. 22, 2004, and constitutes 384K bytes. The listing is incorporated herein by reference.

### FIELD OF THE INVENTION

This invention relates to autonomous, rule-based software agents operative to receive ontologically represented knowledge and operational inputs and perform human-like reasoning to control a system, and more particularly to a system for translating and processing information in a standard ontological form into a database useful for such agent.

### BACKGROUND OF THE INVENTION

A variety of software agents have been developed that receive sensed inputs from a controlled device such as an aircraft for example, and find, evaluate, and apply preexisting knowledge to generate a controlled output for the device, without human supervision or intervention, and are termed “autonomous”. See, for example, Laird, J. E., A. Newell, and P. S. Rosenbloom, Soar: An architecture for general intelligence. Artificial Intelligence, 1987. 33(3): p. 1-64.

Software agents must act responsively, appropriately, and robustly to the complexity inherent in their environments. Because of the primacy of responsiveness as a requirement, many agent frameworks are procedurally oriented, focused on providing agents with a robust, high-performance execution platform. Examples include belief-desired-intention (BDI) architectures (Georgeff, M. and A. L. Lansky. Reactive reasoning and planning in 6^{th} National Conference on Artificial Intelligence. 1987. Seattle, Wash.), Soar (Laird, J. E., A. Newell, and P. S. Rosenbloom, Soar: An architecture for general intelligence. Artificial Intelligence, 1987. 33(3): p. 1-64) and 4D/RCS (Albus, J. S., Engineering of Mind: An Introduction to the Science of Intelligent Systems. 2001: John Wiley and Sons). Such agents have been demonstrated in a spectrum of high-capacity, high-performance environments; however, building and maintaining such agents is resource-intensive. A drawback of procedural systems is that execution knowledge often combines control knowledge and declarative domain knowledge. While these systems execute tasks efficiently, scaling their knowledge bases to larger applications is difficult.

Ontologies can be pivotal tools for addressing the limitations of procedural systems such as autonomous agents. Ontologies are specifications of the terms used in a particular domain and their relations to other terms. Examples are standard ontology language such as XML, RDF and their extensions such as OWL and DAML+OIL. Potentially, ontologies provide: knowledge scalability (the ability to encode and manage very large knowledge bases), reuse of knowledge (across agents and possibly domains), increased robustness (agents can draw on ontological relationships to reason about novel or unanticipated events in the domain), and a foundation for interoperability among heterogeneous agents. These benefits together allow applications to be developed more quickly, maintained less expensively, and adapted to new tasks more readily.

Ontology languages and tools focus on definitions and relationships more than the application of this knowledge in the execution of agent tasks. For information retrieval and web-based applications, the performance costs of using wholly declarative approaches may be acceptable. However, in performance environments, such as robotics and real-time simulation, agent responsiveness is an important requirement. At present, procedural systems fill this application niche.

### SUMMARY OF THE INVENTION

The invention addresses deficiencies in the existing art by accepting, as input, an ontology represented in a standard ontological form, such as OWL or DAML+OIL, and producing, as output, data that is formatted in such a way that an agent in a rule-based system may make use of it. In the preferred embodiment, the translator takes input in the form of sentences in standard ontological languages and converts them to rules. The invention also includes processes for performing reasoning (logical inference) over the ontological representations represented in the agent and “compiling” the inferences into a form that allows the agent to reach conclusions in the same situation in the future without directly accessing the ontology. This learning algorithm utilizes the “chunking” algorithm that is included in Soar but adds a method of querying the ontology knowledge and invoking the chunking mechanism, both of which are novel.

The invention addresses at least the following issues:
Knowledge sharing between agents. The ontology provides a common frame of reference with respect to the nature of the world and things within it. The translator ensures that each agent shares the identical domain of reference (even if other aspects of particular agents are different).
The difficulty of acquiring and entering knowledge about the world into rule-based agents.
The difficulty of reusing (portions of) rule bases when migrating from one application to another.

The translated knowledge can be used in any application of Soar-based systems (e.g., intelligent agents, computational cognitive models, and expert systems) within the fields of artificial intelligence, intelligent agents, software agents, knowledge representation, expert systems, and any other area where it is useful to be able to translate abstract knowledge into a form that is usable by an executable agent. The invention finds application in developing and informing software agents built in Soar systems.

The approach allows Soar agents to be developed more quickly, cheaply, and with better knowledge about the world. It also facilitates knowledge reuse, extending the applicability of ontological knowledge to new domains of application and creating the ability to more easily reuse knowledge.

The invention is incorporated in agent infrastructures generally comprising four components:
1. Ontologies for domain knowledge representations;
2. Translators that bring ontology knowledge to agent applications;
3. Hand-coded ontology inference knowledge for ontological reasoning; and
4. A learning mechanism that caches responses to queries, obviating the need for repeated inference in response to a repeated query.

### BRIEF DESCRIPTION OF THE DRAWINGS

A preferred embodiment of the invention is disclosed in the following specification. The description makes reference to the accompanying drawings in which:

FIG. 1 is a chart illustrating design options for agent access to ontological databases; and

FIG. 2 is a block diagram of the application of the present invention to an agent for command, control and communication.

### DETAILED DESCRIPTION OF THE INVENTION

The preferred embodiment of the invention translates ontological information into rules that are stored in computer files. These rules can then be sourced by the rule-based system.

The current version takes as input an ontology represented in DAML+OIL or OWL XML format, and translates it into rules usable in the Soar cognitive architecture. The program reads the ontology from a DAML+OIL XML file. It then generates a rule for each class within the ontology, and records the generated rules into a different (Soar) file. To use the rules, an agent reads the Soar file. The rules are entered into agent memory. Upon execution, the rules generate a Soar-specific translation of the original ontology in the agent's working memory.

Alternate methods include representing the condition sides of rules (conditions under which rules will apply) and extending the translator to additional ontological relations. In both cases, these represent natural extensions of the basic concept as opposed to fundamental technical/scientific challenges.

Knowledge to perform inference over the ontology is represented in the agent's knowledge of representation language and is integral to the use of the ontology representations within the agent. The system includes a set of hand-coded rules that recognize a set of common ontology queries, and then searches the ontology to answer the queries. The method allows the development of new queries. The query knowledge is included in the system and is provided to the agent via the translation process.

Search over ontological knowledge is triggered via queries posted to a “query” structure on the agent's “world knowledge” blackboard. Each query type is defined by a unique name, used by inference productions to discern one type of query from another. When activated by a query, the inference productions search the ontology. Results are posted under the query structure. Unique tags indicate when a query is not satisfiable by the ontology, and when a query cannot be processed (e.g., syntax errors in query formation).

Performing inference over an ontology during agent execution will result in systems that are generally less responsive than ones that directly combine domain knowledge in procedures. The system employs an explanation-based learning (EBL) technique in Soar to cache the results of ontological inference. Each query to ontology representation is mapped to a Soar impasse, a situation that indicates the agent lacks immediately available knowledge. The impasse leads to a new problem-solving context in which ontology search knowledge is activated. This search attempts to answer the query and resolve the impasse (as above). The chunking algorithm identifies world knowledge elements that were used to answer a query and resolve the impasse. Once this information has been learned, any previously answered query can be re-answered immediately, avoiding the impasse and the consequent deliberation. This learning leads to the automatic integration of the declarative domain knowledge from the ontology into the agent's procedural knowledge.

The present invention may be used with any autonomous agent, but the preferred embodiment is designed for use in conjunction with Soar agents. Soar agents have been developed for complex, highly interactive domains such as tactical aircraft pilots and controllers for military air missions in real-time distributed simulation environments and intelligent adversaries in interactive computer games among others. The design of Soar is based on functional principles such as associative memory retrieval, blackboard memories for state information, and goal-driven processing. A Soar agent's knowledge is stored in the form of productions. Productions are rules that specify some predicate conditions and actions; actions change the state when the predicate conditions are satisfied. Production systems can be used to realize a variety of control structures. This flexibility, along with efficient pattern matching via the RETE algorithm and sophisticated truth maintenance, make Soar a good tool for creating high-performance agent systems.

Production conditions test both the state of an executing procedure and declarative knowledge that provides constraint and rationale for the procedure. For example, when an aircraft pilot agent is maneuvering to launch a missile, productions used in the execution of this behavior test if particular altitude and heading objectives have been reached. The specific values of these goals depend on characteristics of the aircraft being flown, on the particular target, and on the weapon chosen. In naive implementations, declarative facts such as the allowed altitude separation for launch are represented directly in the rules themselves. In more refined formulations, declarative facts are represented elsewhere in agent memory and are referenced indirectly. Additional rules encode the relevant details of each weapon and aircraft and place them into Soar's blackboard memory.

This second approach is superior to the naive approach. It provides greater separation of declarative from procedural knowledge and is generally the rule-of-thumb used in the development of complex Soar systems. However, there are two obvious limitations. First, because the declarative knowledge is encoded by rules, changing the values or adding new ones requires a knowledge engineer that understands the syntax of Soar programs. Second, the refined approach can require more coding and is not enforced by developer tools. As a consequence, the convention is often violated and declarative parameters (e.g., the range of some missile) become hard-coded into rules. Obviously, this intermixing of procedural and declarative knowledge within individual rules leads to code that is very difficult to maintain, and, due to this difficulty, more brittle over time and agent evolution.

Because declarative knowledge is difficult to separate completely from the execution knowledge, it is difficult to reuse even the simple declarative specifications encoded with the refined approach (e.g., aircraft maximum speed). Different agents might draw on that same domain knowledge, but code-level reuse requires that the identical rule be applicable in the new system. Because inference is performed by rules custom-coded for the original system, such reuse is much more difficult to ensure.

### Solution Design Considerations

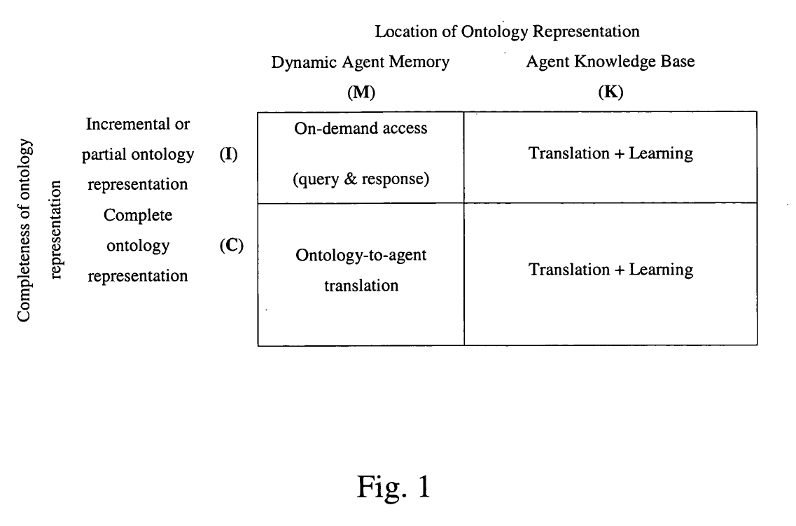

There are four mechanisms by which a procedural agent can utilize an ontology. These mechanisms are listed in FIG. 1. FIG. 1 is organized along two dimensions. First, the ontological information can be represented in the agent's dynamic memory (M) or in the agent's knowledge base (K). In Soar, these dimensions correspond to blackboard memory and production knowledge respectively. The second dimension regards whether the agent represents a complete ontology at one time (C), or incrementally accesses portions of an ontology as needed (I). It is assumed that incremental access can be accomplished as part of an agent's tasks; thus, access to the ontology should occur “on-line” with task execution. However, given the size of most domain ontologies, the complete incorporation of a domain ontology would usually need to be accessed and incorporated off-line from normal task execution.

The most straightforward solution is for the agent to access the ontology via queries and subsequent responses (IM). In this design option, the ontology database can be viewed as simply part of the agent's environment. The agent queries the database when it recognizes it needs information and then receives responses to the queries as external input. This solution has the advantage of existing protocols (such as agent communication languages and Jini) for locating remote databases and interacting with them. In contrast to CM solutions, this solution should scale to very large ontologies.

There are three long-term disadvantages of the Incremental-Memory approach. First, agent knowledge is required to understand when ontology resources are needed, where to find them, and how to evaluate the trustworthiness of responses. Thus, this solution requires highly developed meta-awareness capabilities. Second, the ability of an agent to act correctly and/or responsively may be compromised by the network environment and access to needed information. As the ontology becomes a more critical component of the agent's reasoning, tighter integration of ontology and agent knowledge will be necessary. Third, in the case of simple queries without learning, queries may need to be repeated if memory no longer holds the answer to the prior query. This repetition can lead to performance bottlenecks and require agents to manage memory at a low level (e.g., caching common queries).

Incorporating the results of incremental accesses into the agent's knowledge base (IK) provides a solution to some of these issues. It solves the third problem—queries would automatically be incorporated into an agent's long-term memory. It mitigates the second: because the knowledge is incorporated into the knowledge base upon acquisition, repeating identical queries would not be necessary, resulting in less frequent reference to the external ontology. Creating agent knowledge to encode when to learn and where to find information would provide guidance of what and when to learn, difficult problems in agent learning. The primary drawback of incorporating ontology knowledge via learning is managing changes to the agent knowledge base. Changes necessitate manually removing learned knowledge or leading the agent through a process of “unlearning” previously cached ontology knowledge.

In contrast to the incremental approaches, it is also possible to incorporate complete ontologies within the agent's memory (CM) or knowledge base (CK). These solutions eliminate many of the meta-awareness and network reliability challenges. The agent can access ontology information without needing to access the external environment. Representing all the ontological information in memory (CM) limits this solution to ontologies of modest size, as the inference speed of many agents is a function of the size of memory. Because agent performance is often much less strongly determined by the total size of its knowledge base, this problem can be mitigated by incorporating the ontology information into the agent's long-term knowledge via learning (CK), using a process similar to the IK learning solution outlined above. Unlike the previous learning approach, because the agent is attempting to capture all the ontological information offline from a performance context, a unique challenge in this learning environment is capturing the correct conditions under which the knowledge should be applied when in a performance context. This recognition problem is a critical issue when merging ontological knowledge with task execution and instance knowledge. The agent must encode not only the ontological information but also the conditions that would allow it to recognize that ontological information would be relevant to a future situation.

### Onto2Soar: A Complete Ontology/Agent Memory Solution

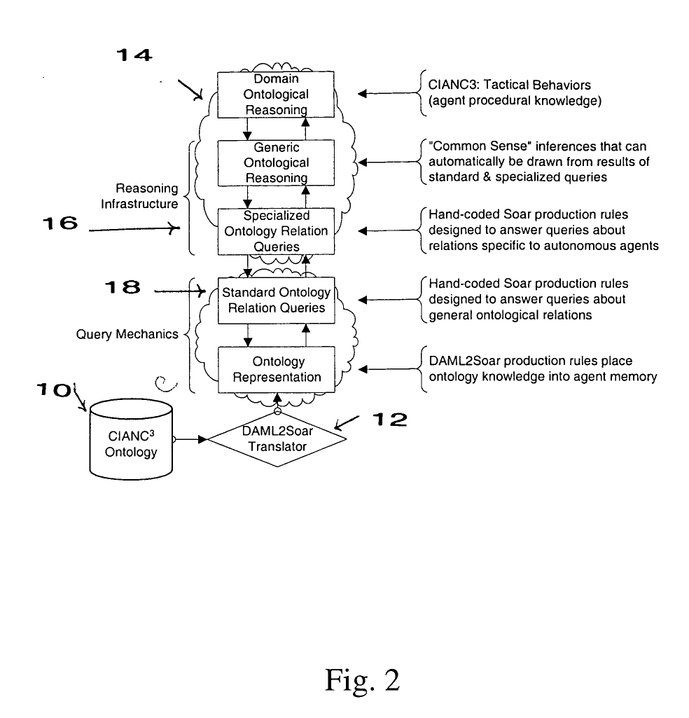

As illustrated in FIG. 2, the CM solution requires three functional components: an ontology language database 10, a translator 12 that converts ontology knowledge to the agent language, and inference knowledge 14 to extract relational information from ontological representations. Because optimal performance remains a primary goal, it is preferred to encode ontological inference knowledge by hand. To further improve performance, Soar's learning mechanism is also used to cache ontological inferences. All of these components are embodied in a program termed Onto2Soar, a system that uses DAML+OIL (DARPA Agent Markup Language+Ontology Interface Language: www.daml.org) for ontology representation and Soar as the agent architecture. The code listings for this program form an appendix to this application and are incorporated by reference. This section outlines each component of Onto2Soar. The following section provides an example that demonstrates the role of each component in providing domain knowledge representation solutions for agents.

### Ontology Language and Tools

As part of the semantic web, many domain and higher-level ontologies have been developed in the DAML+OIL language. Given the widespread use of. DAML+OIL and its representational power, DAML+OIL is employed for ontology representation in the preferred embodiment. To create ontologies and to manage and combine web-based ontologies for our applications, the preferred embodiment employs Protégé (Noy, Fergerson & Munsen, 2000), a DAML+OIL compliant, open-source, Java-based ontology tool. Protégé is designed for data entry and knowledge acquisition, in combination with ontology representation.

One significant advantage of Protégé is its automated support for knowledge acquisition. Whenever a class is defined in the ontology, Protégé automatically creates a form-based data entry window for that class. The forms can be extended and customized, and exported for inclusion in other applications. This capability makes it straightforward to create tools that domain experts can use to enter ontological information. Using Protégé, experts do not require technical knowledge of the agents that will use the knowledge, nor do they need to know the details of the underlying ontology language.

### The Onto2Soar Ontology Translator

The invention implements a translator 12 that maps DAML+OIL ontologies into Soar production rules. Onto2Soar provides straightforward representation of ontology classes and relationships in Soar memory. Users control when and how often ontology information is relayed to Soar, simplifying version control and configuration management. No on-line access to Protégé (or to a Protégé server) is needed during execution. This solution limits interactions between an agent and the ontology knowledge base (transfer is one-way) and requires explicit compilation/translation during agent development.

Onto2Soar creates Soar productions that build a special structure in agent blackboard memory. This structure acts as a data interface layer used by the agent's execution knowledge to send queries to and read responses from the ontology. While the mechanism of Onto2Soar superficially resembles the Complete Ontology-Knowledge approach, it actually fits the CM approach in terms of function. The translated productions provide no solution to the recognition problem, and become immediately active when the agent is instantiated. The system operates to translate to productions (rather than, for example, insert the ontology directly into Soar's blackboard) because this solution does not require run-time access to the agent or modification of the agent architecture.

Onto2Soar supports DAML+OIL classes, properties, super/subclass relations, namespaces, and a small set of queries (discussed below). Each Soar production generated by Onto2Soar corresponds to a specific class from the ontology, with one “boot strap” production to create “world knowledge” and “ontology” divisions of the blackboard memory. Translation computation time does not scale linearly.

Onto2Soar could also easily be adapted to other ontology representation languages, such as OWL, and to other production languages (e.g., CLIPS, JESS, or ACT-R).

### Ontological Inference

Because the complete ontology is represented in agent memory, inference knowledge can be represented within the agent's execution knowledge. Rather than attempting to represent every possible inference, initially, a set of hand-coded rules 16 have been developed that recognize the queries generated at 18 in FIG. 2, and then search the ontology to answer the queries. Additional queries will be supported as additional DAML+OIL representational elements are incorporated within the translator.

Search over ontological knowledge is triggered via queries posted to a “query” structure on the “world knowledge” blackboard. Each query type is defined by a unique name, used by the inference productions to discern one type of query from another. When activated by a query, the inference productions search the ontology. Results are posted under the query structure. Unique tags indicate when a query is not satisfiable by the ontology, and when a query cannot be processed (e.g., syntax errors in query formation).

One of the advantages of this approach is that the importance of performing some particular inference can be considered in the overall context of agent reasoning. For example, if an agent was attempting to evaluate the best weapon and ordnance to choose for a particular target and it recognized that it had come under fire itself, it could deliberately choose to make activities related to evasion more important than reasoning related to weapon selection. This prioritization requires additional knowledge.

### Caching Ontological Inference

Soar includes a learning mechanism, chunking (Newell, 1990), that can be easily applied to cache individual query responses. Each query triggers a Soar impasse, a situation that indicates the agent needs to bring additional knowledge to bear on the problem. The impasse leads to a new problem-solving context in which ontology search knowledge is activated. This search attempts to answer the query and resolve the impasse. The chunking algorithm identifies world knowledge elements that were used to answer a query and resolve the impasse. Once this information has been learned, any previously answered query can be re-answered immediately, avoiding the impasse and the consequent deliberation. This learning leads to the automatic integration of the declarative domain knowledge from the ontology into the agent's procedural knowledge.

Cached inferences may need to be removed or updated when the ontology changes. It is possible to delete all cached inferences when the ontology changes or to identify what cached knowledge needs to be removed or updated, and what can be preserved without change. Ontology versioning solutions, along with tools that examine cached productions, could automate an analysis of which rules to retain and which to excise following ontology modification.

### Networked Command, Control and Communication

The approach outlined above is implemented for Cooperative Interface Agents for Networked Command, Control, and Communications (CIANC³) (Wood, Zaientz, Beard, Frederiksen & Huber, 2003), a Department of the Army Small Business Innovation Research project sponsored by the U.S. Army Research at Fort Knox. The “CIANC³ ontology” is a collection of taxonomies, communication protocols, and deontic relationships for tactical mechanized infantry operations (Kumar, Huber, Cohen & McGee, 2002). For example, the ontology includes descriptions of the types of vehicles one would expect to find on a future infantry battlefield, their weapons, and operational parameters (speeds, size of crew, etc). The ontology is being represented in Protégé and translated into Soar via Onto2Soar.

FIG. 1 illustrates how the agent uses knowledge from the CIANC³ ontology to perform its tasks. Production rules from Onto2Soar instantiate the ontology in the agent's blackboard memory. The ontological knowledge can be queried by searching via “standard” ontological relationships (e.g., subclass). This knowledge would allow an agent to recognize, for example, that “M1A1” is a kind of tank and that the characteristics of its primary weapon determines the maximum range at which it can directly engage hostile forces. These productions are not application or agent specific and can be used in any application using the solution presented here.

At the next higher level, the ontology reasoning infrastructure Onto2Soar includes productions that can reason across domain- or agent-specific relations. These production rules comprise some “common sense” reasoning for the domain and compare the results of ontological queries with the agent's mental representation of the world-state (Beard, Nielsen & Kiessel, 2002). These comparisons allow the agent to draw further domain specific inferences on the basis of ontological relationships amongst objects represented in the agent's perceived world-state. For example, by recognizing that an M1A1's primary weapon is a direct fire weapon, the agent could determine that the tank must have a direct line-of-fire to a target for engagement of that weapon. The productions in the ontological reasoning layer have limited reusability (because the semantics of relations are defined operationally in the productions, rather than formally in the ontology), but provide a very convenient tool for expressing relationships that are difficult to express formally (such as the tactical consequences of the differences between guns and howitzers). Further, these productions can capture complex relationships that could be derived via ontological inference, but only with significant inference effort. This level thus offsets some of the performance costs to be expected when implementing queries without also using the optimizations inherent in databases. At the highest level, agents are able to evaluate their own perceived state in the context of the ontology-based retrievals and make decisions that are consistent with that world state, querying the ontology and acting based on its interpretation of the results.

1. A system for providing an autonomous software agent having a language with ontological information, comprising:
an ontologically arranged database of domain knowledge representations;
a translator operative to receive said ontologically arranged representations and for translating such representations into agent language; and
a source of inference knowledge operative to extract relational information from ontological representations for use by the agent.

2. The system of claim 1 wherein the agent is Soar.

3. The system of claim 2 wherein the ontologically organized domain knowledge representations are in a DAML+OIL form.

4. The system of claim 1 wherein the agent contains a blackboard memory and the system builds a structure in said blackboard memory which acts as a database used by the agent's execution knowledge to send queries to and read responses from the ontology.

5. The system of claim 4 wherein the responses to queries are cached for later use upon repeat of the query.

6. The system of claim 5 including a source of ontology inference knowledge for ontological reasoning adapted to be applied to response to queries.

7. The apparatus of claim 1 wherein input to the translator is in the form of sentences in the standard ontological language.

8. The apparatus of claim 7 including an area in the agent's working memory storing a transformed version of the original ontology.

9. A method of providing an autonomous software agent with ontological information comprising:
generating a database of domain knowledge arranged in a standard ontological language;
translating the ontological knowledge into a form accessible by the agent;
storing said transformed version of the original ontology in the agent's working memory;
generating queries to the transformed version of the original ontology in the agent's working memory; and
caching responses to the queries.

10. The method of claim 9 further including the step of hand coding ontology inference knowledge for ontological reasoning in responding to a query.

11. The method of claim 10 wherein the ontological form is in XML derived format.

12. The method of claim 1 wherein the agent includes the Soar cognition architecture.
